(19) United States
(12) Patent Application Publication
(10) Pub. No.: US 2014/0129923 A1
(43) Pub. Date: May 8, 2014

(54) SERVER HOSTING WEB-BASED APPLICATIONS ON BEHALF OF DEVICE

(71) Applicant: KT Corporation, Seongnam-si (KR)

(72) Inventors: Young-il YOO, Seongnam-si (KR); Chan-hui KANG, Yongin-si (KR); Dong-hoon KIM, Yongin-si (KR); Mi-jeom KIM, Anyang-si (KR); I-gil KIM, Suwon-si (KR); Gyu-tae BAEK, Seoul (KR); Ji-hoon HA, Gwacheon-si (KR); Yoon-bum HUH, Seoul (KR)

(73) Assignee: KT Corporation, Seongnam-si (KR)

(21) Appl. No.: 14/072,214

(22) Filed: Nov. 5, 2013

(30) Foreign Application Priority Data
Nov. 5, 2012 (KR) 10-2012-0124402

(51) Int. Cl. G06F 17/22

(52) U.S. Cl. CPC G06F 17/2247
USPC 715/234

(57) ABSTRACT

In at least one example embodiment, a method may include generating, regarding a rendered HTML page, an output image having a plurality of macroblocks; classifying each of the plurality of macroblocks into one of a variable macroblock and an invariable macroblock; generating an encoding map regarding the output image based at least in part on the result of the classifying; and encoding the output image based at least in part on the encoding map.

### TECHNICAL FIELD

The embodiments described herein pertain generally to a server that hosts or executes web-based applications on behalf of a device.

### BACKGROUND

A television device may enable a user to not only watch television content or video on demand (VOD) but may also host plural applications.

### SUMMARY

In one example embodiment, a method may include method may include generating, regarding a rendered HTML page, an output image having a plurality of macroblocks; classifying each of the plurality of macroblocks into one of a variable macroblock and an invariable macroblock; generating an encoding map regarding the output image based at least in part on the result of the classifying; and encoding the output image based at least in part on the encoding map.

In another example embodiment, a server may include a renderer configured to generate, regarding a rendered HTML page, an output image having a plurality of macroblocks; an analyzer configured to classify each of the plurality of macroblocks into one of a variable macroblock and an invariable macroblock; an encoding map generator configured to generate an encoding map regarding the output image based at least in part on the result of the classifying; and an encoder configured to encode the output image based at least in part on the encoding map.

In yet another example embodiment, a system may include a server configured to: generate, regarding a rendered HTML page, an output image having a plurality of macroblocks; classify each of the plurality of macroblocks into a variable macroblock and an invariable macroblock; generate an encoding map regarding the output image based at least in part on the result of the classifying; encode the output image based at least in part on the encoding map; and transmit the encoded output image, and a device configured to: receive the encoded output image from the server; and display the encoded output image.

computer-readable storage medium having thereon computer-executable instructions that, in response to execution, may cause a device to perform operations including: executing a plurality of web-based applications; providing at least one respective TCP connection to each of the plurality of web-based applications; and transmitting data packets from at least one of the plurality of web-based applications to an external device via the at least one respective TCP connection.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which a server hosts and/or executes a web-based application, in accordance with various embodiments described herein;

FIG. 2 shows an example configuration of a server on which a web-based application may be hosted and executed, in accordance with embodiments described herein,

FIG. 3 shows an illustrative example of an output image generated by a server by which at least portions of hosting of a web-based application may be implemented, in accordance with various embodiments described herein;

FIG. 4 shows an illustrative example of an encoding map of an output image generated by a server by which at least portions of hosting of a web-based application may be implemented, in accordance with various embodiments described herein;

FIG. 5 shows an illustrative example of a previous output image and a current output image generated by a server by which at least portions of hosting of a web-based application may be implemented, in accordance with various embodiments described herein;

FIG. 6 shows an example processing flow of operations to implement at least portions of encoding of an output image generated by executing a web-based application may be implemented, in accordance with various embodiments described herein;

FIG. 7 shows an illustrative computing embodiment, in which any of the processes and sub-processes of hosting and executing web-based applications may be implemented as computer-readable instructions stored on a computer-readable medium, in accordance with embodiments described herein.

All of the above may be arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

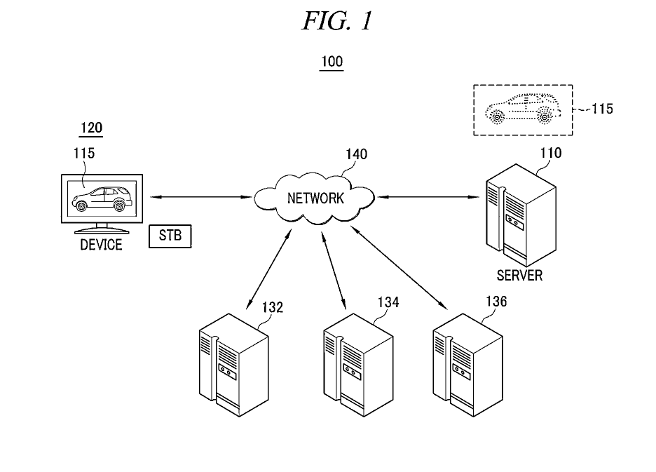

FIG. 1 shows an example system configuration 100 in which a server 110 hosts and/or executes a web-based application on behalf of a device 120, in accordance with various embodiments described herein. As depicted in FIG. 1, system configuration 100 may include, at least, server 110; device 120; a web server 132 that may be representative of one or more servers providing web pages; a content provider 134 that may be representative of one or more servers operated by a content provider; and one or more of third-party servers 136. At least two or more of server 110, device 120, web server 132, content provider 134, and one or more of third-party servers 136 may be communicatively connected to each other via a network 140.

Server 110, operated by a virtualization/cloud service provider, may be configured to execute a web-based application to generate an output image 115, and to transmit, to device 120, generated output image 115 for display thereof. Thus, server 110 may provide a user of device 120 with the web-based application on device 120 via server 110.

Server 110 may be further configured to communicatively interact with at least one of web server 132, content provider 134, and one or more of third-party servers 136, each of which may be operated by other service provider(s) from the virtualization/cloud service provider, to execute the web-based application. For example, when server 110 receives, from device 120, a service request to execute the web-based application, server 110 may interact with web server 132 to execute and/or host the web-based application on a web-browser of server 110. Thus, server 110 may generate the output image 115 by executing and/or hosting the web-based application.

Further, by way of example, if the executed or executing web-based application includes any media content, such as television content, video on demand (VOD) content, image content, music content, various other media content, etc., server 110 may interact with content provider 134 to execute the web-based application. That is, server 110 may transmit a request for at least some of the media content to content provider 134, and receive at least some of the requested media content from content provider 134.

Server 110 may be further configured to encode output image 115 so that low-performance device 120 may display the encoded output image 115, and transmit, to device 120, the encoded output image 115. Thus, server 110 may enable device 120 to display the encoded output image 115 without regard to hardware specifications of device 120.

Device 120 may refer to a display apparatus configured to play various types of media content, such as television content, video on demand (VOD) content, music content, various other media content, etc. Device 120 may further refer to at least one of an IPTV (Internet protocol television), a DTV (digital television), a smart TV, a connected TV or a STB (set-top box), a mobile phone, a smart phone, a tablet computing device, a notebook computer, a personal computer or a personal communication terminal. Non-limiting examples of such display apparatuses may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Further, in accordance with various embodiments described herein, device 120 may be unable to host a web browser engine, thus device 120 may be configured to receive, from server 110, encoded output image 115, and to display encoded output image 115 as a zero client. Examples of such embodiments of device 120 may refer to a low-performance device including the IPTV or the STB.

Device 120 may be configured to receive, via a remote controller (not illustrated), a user input that clicks or selects or otherwise activates an icon or a button displayed on output image 115 or which slides output image 115 vertically or horizontally. Then, device 120 may transmit the received user input to server 110, and receive a subsequent output image corresponding to the user input from server 110.

Web server 132, hosted by one or more web site providers, may refer to either hardware or software that helps to deliver, to server 110, web content that may be accessed through the Internet on server 110. For example, web server 132 may receive a request for a web page from server 110, and transmit, to server 110, the web content including, i.e., an “html” file corresponding to the requested web page.

Content provider 134 may refer to one or more servers operated by one or more content providers, and may be configured to receive, from server 110, a request for television content, video on demand (VOD) content, image content, music content, etc., i.e., requested media content, that may be included in the web page, and to further transmit the requested media content to server 110.

One or more of third-party servers 136 may be operated by, e.g., one or more advertisement companies. As referenced herein, the advertisement companies may generate plural advertisement content with respect to particular goods or services. Further, one or more third-party servers 136 hereafter may be referred as “advertisement server 136” without limiting such features in terms of quantity, unless context requires otherwise.

Third-party server 136 as a service host may be configured to receive, from server 110, a request for advertisement content, and to transmit the corresponding advertisement content to server 110. As referenced herein, the advertisement content may be representative of, for example, determining appropriate advertisement content for a user of device 120, and providing the user with the determined advertisement content. That is, when receiving, from server 110, a request for advertisement content, third-party server 136 may select advertisement content appropriate to the user from among the plural generated advertisement content by using, for example, a content usage history for the user and/or user's preference. Then, third-party server 136 may transmit, to server 110, the selected advertisement content as a response to the request.

A role of third-party server 136 is not limited to the service host, by way of example, third-party server 136 may be implemented as a service client that transmits, to server 110, a request for information regarding the user. As referenced herein, the information regarding the user may represent the content usage history, and/or the user's preference as set forth above.

Network 140, which may be configured to communicatively couple server 110, device 120 and external devices 130, may be implemented in accordance with any wireless network protocol, such as a mobile radio communication network including at least one of a 3rd generation (3G) mobile telecommunications network, a 4th generation (4G) mobile telecommunications network, any other mobile telecommunications networks, WiBro (Wireless Broadband Internet), Mobile WiMAX, HSDPA (High Speed Downlink Packet Access) or the like. Alternatively, network 140 may include at least one of a near field communication (NEC), radio-frequency identification (REID) or peer to peer (P2P) communication protocol

Thus, FIG. 1 shows an example system configuration 100 in which server 110 hosts and/or executes a web-based application instead of device 120, in accordance with various embodiments described herein.

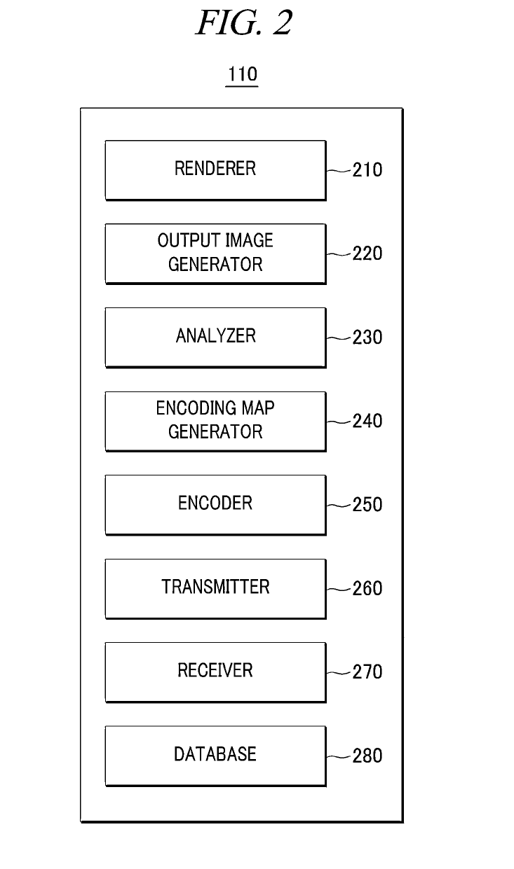

FIG. 2 shows an example configuration 200 of server 110 on which a web-based application may be hosted and executed, in accordance with embodiments described herein. As depicted in FIG. 2, server 110, first described above with regard to FIG. 1, may include a renderer 210, an output image generator 220, an analyzer 230, an encoding map generator 240, an encoder 250, a transmitter 260, a receiver 270 and a database 280.

Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of renderer 210, output image generator 220, analyzer 230, encoding map generator 240, encoder 250, transmitter 260, receiver 270 and database 280 may be included in an instance of an application hosted by server 110.

Renderer 210 may refer to a web engine, e.g., a web browser, and be a component or module that is programmed and/or configured to render an HTML page by executing web content that is received from web server 132. As referenced herein, the received web content may include, an “html” file corresponding to the HTML page.

Output image generator 220 may be a component or module that is programmed and/or configured to generate, regarding the rendered HTML page, an output image having a plurality of macroblocks. As referenced herein, a size/length of each of the plurality of macroblocks or the number of the plurality of macroblocks may be pre-determined by output image generator 220. Alternatively, the size of each of the plurality of macroblocks or the number of the plurality of macroblocks may be adaptively determined based at least in part on hardware specifications of device 120 by output image generator 220.

Analyzer 230 may be a component or module that is programmed and/or configured to parse the HTML page to analyze characteristic for the plurality of macroblocks. As referenced herein, the HTML page may be parsed by detecting a plurality of objects displayed on the output image; detecting characteristics of each of the plurality of objects; and matching each of the detected objects and/or the detected characteristics with at least one corresponding macroblock.

Analyzer 230 may be further programmed and/or configured to classify each of the plurality of macroblocks into one of a variable macroblock and an invariable macroblock. As referenced herein, analyzer 230 may classify each of the plurality of macroblocks by comparing a previous output image and the output image currently generated by output image generator 220.

For example, each of the plurality of macroblocks may include update information, and update information for the variable macroblock may indicate that the variable macroblock may be updated from a corresponding one of the previous output image. Similarly, update information for the invariable macroblock may indicate that the invariable macroblock was not updated from a corresponding one of the previous output image.

Analyzer 230 may be further programmed and/or configured to classify a content type of the variable macroblock into one of a text, an image and a video. By way of example, but not limitation, analyzer 230 may detect the content type of the variable macroblock by using at least one of the “html” file, the rendered HTML page, or the parsed HTML page.

Analyzer 230 may be further programmed and/or configured to determine a quantization level of the variable macroblock based at least in part on the content type of the variable macroblock. As referenced herein, quantization level may correspond to resources allocated for the variable macroblock by encoder 250 to encode the variable macroblock. For example, the quantization level for text content may be lower than the quantization level for video content, so that more resources may be allocated to the text content. That is, if fewer resources are allocated to the text content relative to video content, the text content may be blurry relative to the video content.

Analyzer 230 may be further programmed and/or configured to detect a motion vector of the variable macroblock, based at least in part on the parsed HTML page. As referenced herein, the motion vector may represent a motion of the object matched with the variable macroblock. For example, analyzer 230 may detect the motion vector by detecting a position of the variable macroblock of the output image relative to a position of a corresponding one of the previous output image.

Encoding map generator 240 may be a component or module that is programmed and/or configured to generate an encoding map regarding the output image based at least in part on the result of the classifying.

Thus, as referenced herein, the generated encoding map may include information regarding at least one of the variable macroblock or the invariable macroblock; the content type; the quantization level; or the motion vector for each of the plurality macroblocks.

Encoder 250 may be a component or module that is programmed and/or configured to encode the output image based at least in part on the encoding map. By way of example, but not limitation, encoder 250 may encode only the variable macroblock while skipping encoding of the invariable macroblock. Further, encoder 250 may encode only the variable macroblock by using the determined quantization level.

Encoder 250 may be further programmed and/or configured to encode the output image at an irregular time interval when the variable macroblock is updated, or to encode the output image periodically at a regular time interval.

Transmitter 260 may be a component or module that is programmed and/or configured to transmitting the encoded output image to device 120 to allow device 120 to display the encoded output image.

Receiver 270 may be a component or module that is programmed and/or configured to receive, from device 120, information regarding a user input that slides vertically or horizontally the encoded output image displayed on device 120; or clicks or selects, or otherwise activates a link or an icon/button displayed on the transmitted encoded output image. Then, receiver 270 may transfer the information regarding the user input to request renderer 210 to render a next HTML page with respect to the activating; or to request output image generator 220 to generate a next output image with respect to the scrolling.

Database 280 may be configured to store data, including data input to or output from the components of server 110. Non-limiting examples of such data may include the “html” file which is received from web server 132.

Further, by way of example, database 280 may be embodied by at least one of a hard disc drive, a ROM (Read Only Memory), a RAM (Random Access Memory), a flash memory, or a memory card as an internal memory or a detachable memory of server 110.

In summary, device 120 which is old-fashioned or low-performanced may be unable to host a web engine e.g., a web browser. Thus, device 120 may not render, for itself, an HTML page by executing web content including an “html” file that is received from web server 132, so that server 110 may render the HTML page on behalf of device 120 to generated an output image. Further, server 110 may parse the HTML page to analyze characteristics for objects included in the output image, and may encode the generated output image by just using the parsing result of the HTML page without redundant whole encoding of output image.

Thus, FIG. 2 shows example configuration 200 of server 110 on which a web-based application may be hosted and executed, in accordance with embodiments described herein.

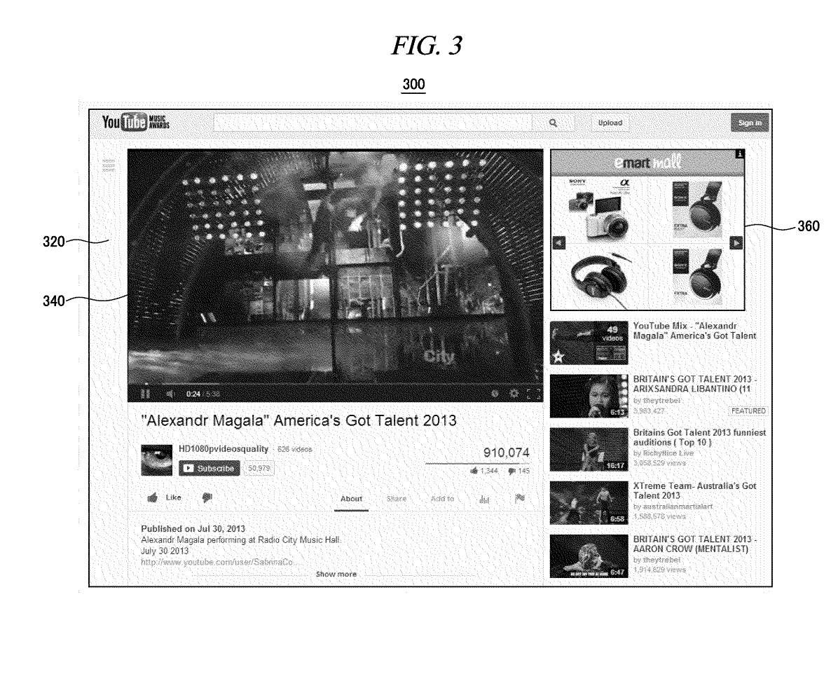

FIG. 3 shows an illustrative example of an output image 300 generated by server 110 by which at least portions of hosting of a web-based application may be implemented, in accordance with various embodiments described herein.

As depicted in FIG. 3, server 110 may generate output image 300 including a first area 320, a second area 340, and a third area 360 that is to be partially or entirely encoded and transmitted from server 110 to device 120. As referenced herein, first area 320 may corresponds to web server 132, and second area 340 may corresponds to content provider 134, and third area 360 may corresponds to third-party server 136, e.g., advertisement server 136. That is, first area 320, second area 340, and third area 360 may be determined based at least in part on corresponding respective interworking servers.

By way of example, but not limitation, server 110 may generate first area 320 by receiving and executing an “html” file from web server 132 operated by the “YouTube′”. Further, server 110 may generate second area 340 by receiving video content, Uniform Resource Locator (URL) address of which may be included in the “html” file, from content provider 134 operated by the “YouTube′”. Further, server 110 may generate third area 360 representing advertisement content, URL address of which may be included in the “html” file, received from third-party server 136. Although output image 300 may be divided into three areas 310, 320, and 330 in FIG. 3, the embodiments described herein are in no way limited to three of such areas.

Here, first area 320 may include at least one text object, or at least one image object, or combination thereof. Further, third area 360 may include at least one image content. Thus, server 110 may determine first area 320 and third area 360 as invariable macroblocks.

However, second area 340 corresponding to the video content may be regularly updated, so that server 110 may determine second area 340 as variable macroblocks, and server 110 may regularly encode second area 340.

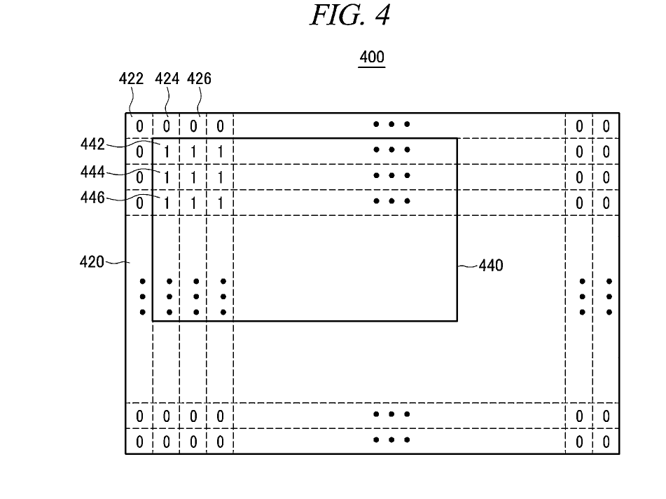

FIG. 4 shows an illustrative example of an encoding map 400 of output image 300 generated by server 110 by which at least portions of hosting of a web-based application may be implemented, in accordance with various embodiments described herein.

As referenced herein, server 110 may generate encoding map 400 including a non-encoding area 420, and an encoding area 440. According to output image 300 in FIG. 3, first area 420 may include at least one text object, or at least one image object, or combination thereof. Thus, server 110 may determine each of macroblocks of first area 420 as invariable macroblock, and allocate “0”, refers to the invariable macroblock, to each of the invariable macroblocks included in first area 420. Thus, invariable macroblocks 422 to 426 may display “0”.

Similarly, according to output image 300 in FIG. 3, second area 440 may include video content. Thus, server 110 may determine each of macroblocks of second area 440 as variable macroblock, and allocate “1”, refers to the variable macroblock, to each of the invariable macroblocks included in second area 440. Thus, variable macroblocks 442 to 446 may display “1”.

In some embodiment, each of variable macroblocks 442 to 446 may further include at least one value of a motion vector or a quantization level. In this case, if a position of each of plurality of objects included in output image 300 in FIG. 3 may not be moved, the value of the motion vector for each of variable macroblocks 442 to 446 may be “0”. Further, the quantization level for each of variable macroblocks 442 to 446 may be determined appropriately to the video content as a content type of variable macroblocks 442 to 446.

Further, according to a size/length of each of the illustrated plurality of macroblocks or the number of the illustrated plurality of macroblocks, this is provided by way of an example only and not by way of a limitation.

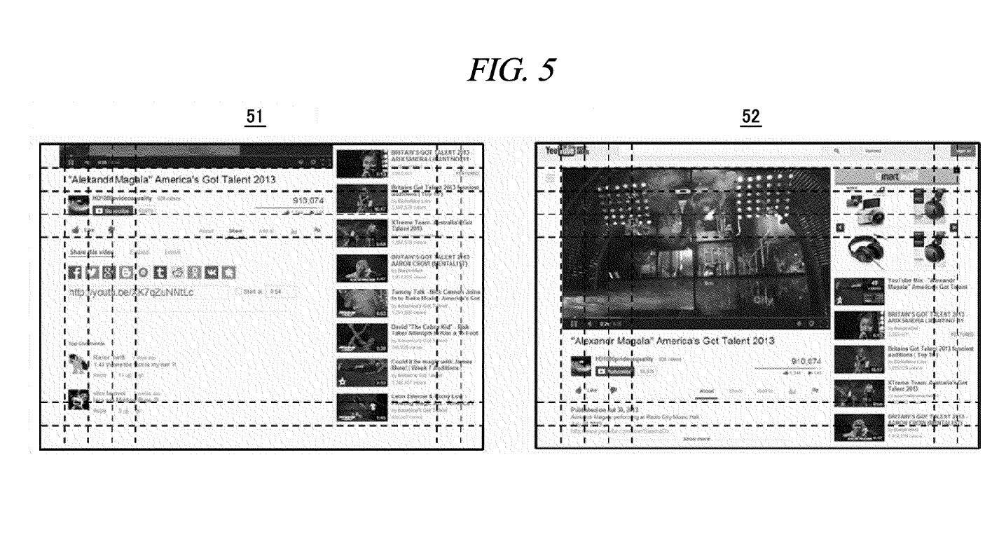

FIG. 5 shows an illustrative example of a current output image 51 and a previous output image 52 generated by server 110 by which at least portions of hosting of a web-based application may be implemented, in accordance with various embodiments described herein.

As depicted in FIG. 5, server 110 may generate previous output image 52 and current output image 51 based at least in part on information regarding a user input, such as scrolling, received from device 120.

Comparing each macroblock included in previous output image 52 with each corresponding macroblock included in current output image 51, content/object of each of macroblocks may be updated. Thus, according to current output image 51, server 110 may determine each of the macroblocks included in current output image 51 as variable macroblocks.

In this case, because a position of each of objects included in current output image 51 is changed relative to previous output image 52, according to each of the objects, each of variable macroblocks included in current output image 51 may be different from each of corresponding variable macroblocks included in previous output image 52. Thus, based at least in part on the changing of respect position of each of the objects, server 110 may allocate particular value to motion vector for each of variable macroblocks.

Further, server 110 may determine a quantization level for each of variable macroblocks based at least in part on a content type for each of variable macroblocks.

Further, according to a size/length of each of the illustrated plurality of macroblocks or the number of the illustrated plurality of macroblocks, this is provided by way of an example only and not by way of a limitation.

Thus, FIG. 3 shows an illustrative example of output image 300 generated by server 110, FIG. 4 shows an illustrative example of encoding map 400 of output image 300 generated by server 110, FIG. 5 shows an illustrative example of current output image 51 and previous output image 52 generated by server 110 by which at least portions of hosting of a web-based application may be implemented, in accordance with various embodiments described herein.

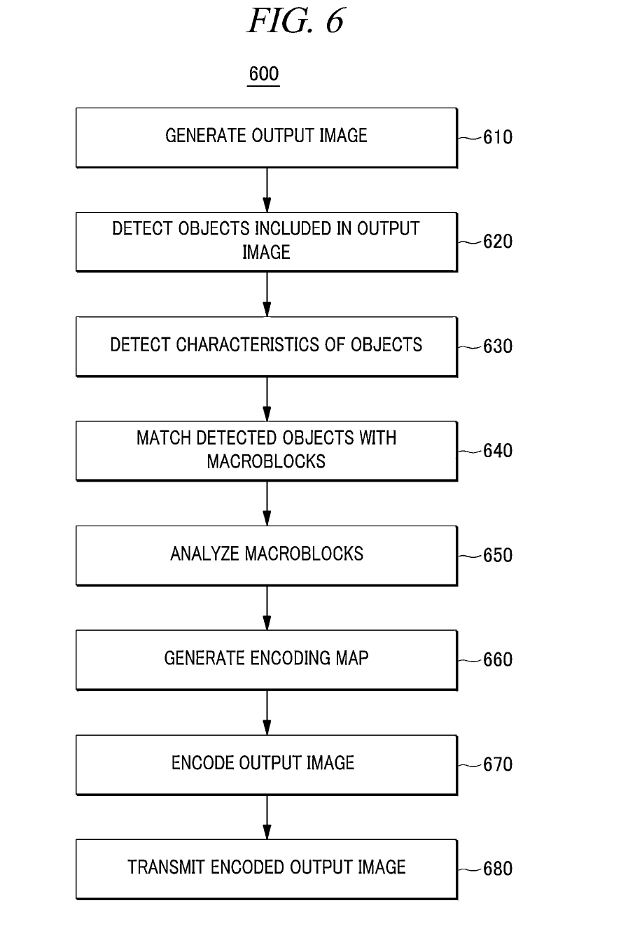

FIG. 6 shows an example processing flow of operations to implement at least portions of encoding of an output image generated by executing a web-based application may be implemented, in accordance with various embodiments described herein.

The operations of processing flow 600 may be implemented in system configuration 100 including server 110, device 120, and external servers 130 as illustrated in FIG. 1. Processing flow 600 may include one or more operations, actions, or functions as illustrated by one or more blocks 610, 620, 630, 640, 650, 660, 670 and/or 680. Although illustrated as discrete blocks, various blocks may be divided into additional blocks, combined into fewer blocks, or eliminated, depending on the desired implementation. Processing may begin at block 610.

Block 610 (Generate Output Image) may refer to server 110 generating an output image by rendering a HTML page. As referenced herein, the HTML page may be rendered by executing an “html” file received from web server 132. Processing may proceed from block 610 to block 620.

Block 620 (Detect Objects included in Output Image) may refer to server 110 detecting a plurality of objects from among the generated output image. Processing may proceed from block 620 to block 630.

Block 630 (Detect Characteristic for each of Objects) may refer to server 110 detecting characteristic, such as a content type, for each of the plurality of objects. As referenced herein, the content type may include, by way of example, video content, text content, image content. Processing may proceed from block 630 to block 640.

Block 640 (Match Detected Objects With Macroblocks) may refer to server 110 matching the detected object and the detected characteristic for the detected object with each of the plurality of macroblocks. Processing may proceed from block 640 to block 650.

Block 650 (Analyze Macroblocks) may refer to server 110 analyzing each of the plurality of macroblocks by comparing with a previous output image. For example, server 110 may classify each of the plurality of macroblocks into one of a variable macroblock and an invariable macroblock. Further, server 110 may determine a motion vector for each of variable macroblocks. Further, server 110 may determine a quantization level of the variable macroblock based at least in part on the content type of the variable macroblock. Processing may proceed from block 650 to block 660.

Block 660 (Generate Encoding Map) may refer to server 110 generating an encoding map regarding the output image based at least in part on the result of the analyzing. Processing may proceed from block 660 to block 670.

Block 670 (Encode Output Image) may refer to server 110 encoding the output image based at least in part on the generated encoding map. For example, device 110 may encode the output image further based at least in part a hardware specification of device 120 that is to be receive the encoded output image from server 110. Processing may proceed from block 670 to block 680.

Block 680 (Transmit Encoded Output Image) may refer to server 110 transmitting the encoded output image to allow device 120 to display the transmitted encoded output image.

In summary, device 120, which may be a low-performance device, may be unable to host a web engine e.g., a web browser. Thus, device 120 may not render, for itself, an HTML page by executing web content including an “html” file that is received from web server 132, so that server 110 may render the HTML page on behalf of device 120 to generated an output image. Further, server 110 may parse the HTML page to analyze characteristics for objects included in the output image, and may encode the generated output image by just using the parsing result of the HTML page without redundant whole encoding of output image.

Thus, FIG. 6 shows example processing flow 600 of operations to implement at least portions of encoding of an output image generated by executing a web-based application may be implemented, in accordance with various embodiments described herein.

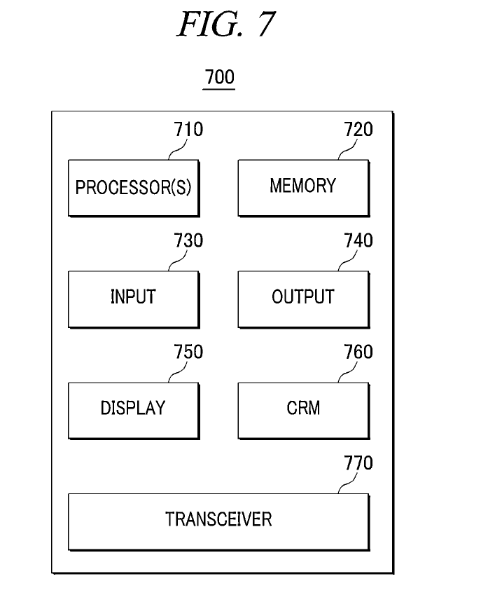

FIG. 7 shows an illustrative computing embodiment, in which any of the processes and sub-processes of hosting and executing web-based applications may be implemented as computer-readable instructions stored on a computer-readable medium, in accordance with embodiments described herein. The computer-readable instructions may, for example, be executed by a processor of a device, as referenced herein, having a network element and/or any other device corresponding thereto, particularly as applicable to the applications and/or programs described above corresponding to the example system configuration 100 for transactional permissions.

In a very basic configuration, a computing device 700 may typically include, at least, one or more processors 710, a system memory 720, one or more input components 730, one or more output components 740, a display component 750, a computer-readable medium 760, and a transceiver 770.

Processor 710 may refer to, e.g., a microprocessor, a microcontroller, a digital signal processor, or any combination thereof.

Memory 720 may refer to, e.g., a volatile memory, non-volatile memory, or any combination thereof. Memory 720 may store, therein, an operating system, an application, and/or program data. That is, memory 720 may store executable instructions to implement any of the functions or operations described above and, therefore, memory 720 may be regarded as a computer-readable medium.

Input component 730 may refer to a built-in or communicatively coupled keyboard, touch screen, or telecommunication device. Alternatively, input component 730 may include a microphone that is configured, in cooperation with a voice-recognition program that may be stored in memory 730, to receive voice commands from a user of computing device 700. Further, input component 720, if not built-in to computing device 700, may be communicatively coupled thereto via short-range communication protocols including, but not limitation, radio frequency or Bluetooth.

Output component 740 may refer to a component or module, built-in or removable from computing device 700, that is configured to output commands and data to an external device.

Display component 750 may refer to, e.g., a solid state display that may have touch input capabilities. That is, display component 750 may include capabilities that may be shared with or replace those of input component 730.

Computer-readable medium 760 may refer to a separable machine readable medium that is configured to store one or more programs that embody any of the functions or operations described above. That is, computer-readable medium 760, which may be received into or otherwise connected to a drive component of computing device 700, may store executable instructions to implement any of the functions or operations described above. These instructions may be complimentary or otherwise independent of those stored by memory 720.

Transceiver 770 may refer to a network communication link for computing device 700, configured as a wired network or direct-wired connection. Alternatively, transceiver 770 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method comprising:
generating, regarding a rendered HTML page, an output image having a plurality of macroblocks;
classifying each of the plurality of macroblocks into one of a variable macroblock and an invariable macroblock;
generating an encoding map regarding the output image based at least in part on the result of the classifying; and
encoding the output image based at least in part on the encoding map.

2. The method of claim 1, wherein the variable macroblock includes update information that indicates that the variable macroblock was updated from a corresponding one of a previous output image, and
wherein the invariable macroblock includes update information that indicates that the invariable macroblock was not updated from a corresponding one of the previous output image.

3. The method of claim 1, further comprising:
classifying a content type of the variable macroblock into one of a text, an image or a video.

4. The method of claim 1, further comprising:
parsing the HTML page; and
detecting a motion vector of the variable macroblock, based at least in part on the parsed HTML page, that represents a position of the variable macroblock of the output image relative to a position of a corresponding one of a previous output image.

5. The method of claim 3, further comprising:
determining a quantization level of the variable macroblock based at least in part on the content type of the variable macroblock.

6. The method of claim 5, wherein the encoding includes encoding the variable macroblock using the determined quantization level.

7. The method of claim 1, wherein the encoding of the output image is executed at an irregular time interval when the variable macroblock is updated.

8. The method of claim 1, wherein the encoding of the output image is periodically performed at a regular time interval.

9. The method of claim 1, further comprising:
transmitting the encoded output image to a device that is unable to host a web browser engine.

10. The method of claim 4, wherein the parsing of the HTML page comprises:
detecting a plurality of objects displayed on the output image;
detecting characteristics of each of the plurality of objects; and
matching each of the detected objects with at least one of the plurality of macroblocks.

11. The method of claim 10, further comprising:
detecting a motion vector of the variable macroblock based at least in part on the parsed HTML page,
wherein the motion vector represents a motion of the object matched with the variable macroblock.

12. A server comprising:
a renderer configured to generate, regarding a rendered HTML page, an output image having a plurality of macroblocks;
an analyzer configured to classify each of the plurality of macroblocks into one of a variable macroblock and an invariable macroblock;
an encoding map generator configured to generate an encoding map regarding the output image based at least in part on the result of the classifying; and
an encoder configured to encode the output image based at least in part on the encoding map.

13. The server of claim 12, wherein the variable macroblock includes update information that indicates that the variable macroblock was updated from a corresponding one of a previous output image, and
wherein the invariable macroblock includes update information that indicates that the invariable macroblock was not updated from a corresponding one of the previous output image.

14. The server of claim 12, wherein the analyzer is further configured to classify a content type of the variable macroblock into one of a text, an image and a video.

15. The server of claim 14, wherein the analyzer is further configured to determine a quantization level of the variable macroblock based at least in part on the content type of the variable macroblock.

16. The server of claim 15, wherein the encoder is further configured to encode the variable macroblock by using the determined quantization level.

17. The server of claim 12, wherein the analyzer is further configured to:
detect a plurality of objects displayed on the output image;
detect characteristics of each of the plurality of objects; and
match each of the detected objects with at least one of the plurality of macroblocks.

18. A system, comprising:
a server configured to:
generate, regarding a rendered HTML page, an output image having a plurality of macroblocks;
classify each of the plurality of macroblocks into a variable macroblock and an invariable macroblock;
generate an encoding map regarding the output image based at least in part on the result of the classifying;
encode the output image based at least in part on the encoding map; and
transmit the encoded output image, and
a device configured to:
receive the encoded output image from the server; and
display the encoded output image.

19. The system of 18, wherein the device is further configured to:
receive a user input to the displayed output image, and to transmit the user input to the server, and
wherein the server is further configured to:
render the HTML page to generate a next output image; and
encode the next output image and transmit the encoded next output image to the device.

20. The system of 19, wherein the variable macroblock includes update information that indicates that the variable macroblock was updated from a corresponding one of a previous output image, and
wherein the invariable macroblock includes update information that indicates that the invariable macroblock was not updated from a corresponding one of the previous output image.
